(19) United States
(12) Patent Application Publication
(10) Pub. No.: US 2007/0085659 A1
(43) Pub. Date: Apr. 19, 2007

(54) Sensor system with activation alert

(75) Inventor: John R. Anderson, White Lake, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/581,299

(22) Filed: Oct. 16, 2006

Related U.S. Application Data
(60) Provisional application No. 60/728,011, filed on Oct. 14, 2005.

(51) Int. Cl. B60R 25/00

(52) U.S. Cl. 340/5.72; 307/10.2; 340/426.36; 340/5.54

(57) ABSTRACT

A method of communicating an activation alert to an electronic system comprises receiving an input signal, evaluating the validity of the input signal, communicating an activation alert signal to a computer module at least partially simultaneously with the evaluation of the input signal in response to a predefined prompt, and communicating a validated output signal to the computer module for controlling the electronic system. In one example, the activation alert signal is communicated to the computer module in response to a confidence level percentage of at least 80%. In yet another example, the electronic system comprises a passive entry and starting (PASE) system which unlocks a vehicle door in response to the receipt of a validated output signal by the computer module.

### CROSS-REFERENCE TO RELATED APPLICATIONS

This application claims priority to U.S. Provisional Application No. 60/728,011, filed Oct. 14, 2005.

### BACKGROUND OF THE INVENTION

This invention generally relates to sensor systems, and more particularly to a smart sensor system having activation alert capabilities.

Many electronic products, especially in the automotive and medical fields, require a rapid response to a sensed input signal. Input devices, such as smart sensors, are known which are used to evaluate the validity of an input signal prior to communicating an output signal for actuating an electronic system. Mechanical switches and relays which generate the input signals are electrically noisy when they change from open to closed or closed to open. The transition from a low input signal (i.e., an “off” position of the mechanical switch or relay) to a high input signal (i.e., an “on” position of the mechanical switch or relay) creates a signal bounce for a certain period of time. During this period of time, such as a time period of 60 milliseconds, the input device is uncertain whether the input signal is a true signal for which an output signal must be communicated to actuate the appropriate electronic system. Therefore, the input signal must be analyzed and filtered to determine whether a true signal change has occurred.

Smart sensors often include special circuitry or microprocessors to evaluate the validity of an input signal prior to communicating the output signal to the electronic system. The smart sensor utilizes the microprocessor or special circuitry to filter and evaluate the input signal while the input signal is bouncing. Once the smart sensor determines that the input signal is valid, the smart center communicates an output signal to a computer module of an electronic system.

Computer modules which control electronic systems often utilize sleep modes for preserving system power during periods of time in which the electronic systems are not in use. For example, a vehicle passive entry and starting (PASE) system may be programmed to enter a sleep mode when the vehicle is turned off. Therefore, the output signal communicated from the smart sensor will wake up the computer module of the electronic system. The computer module must then go through a startup and initialization sequence in which the circuitry of the computer module prepares to receive a valid output signal from the smart sensor and perform the functionality of the electronic system.

Disadvantageously, the amount of time required to startup and initialize the computer module is added to the amount of time required to debounce the input signal. Therefore, the electronic system reaction time is increased which may result in an additional 50 milliseconds or more of reaction time. This additional reaction time may be unacceptable to a customer.

Accordingly, it is desirable to provide a sensor system having activation alert capabilities and that provides the ability to filter input signals in parallel with the start up and initialization sequences of a computer module.

### SUMMARY OF THE INVENTION

An example method of communicating an activation alert to an electronic system comprises receiving an input signal, evaluating the validity of the input signal, communicating an activation alert signal to a computer module in response to a predefined prompt, and communicating a validated output signal to the computer module for controlling the electronic system. The activation alert is communicated at least partially simultaneously with the evaluation of the input signal.

In one example, the validity of the input signal is evaluated by analyzing the input signal in 5 millisecond intervals and filtering the input signal to determine the validity thereof. In another example, the activation alert signal is communicated to the computer module in response to a confidence level percentage of at least 80%. In yet another example, the electronic system comprises a passive entry and starting (PASE) system which unlocks a vehicle door in response to the receipt of a validated output signal by the computer module.

An example sensor system for controlling a vehicle PASE system includes a keypad sensor having a microprocessor and a computer module. The microprocessor of the keypad sensor analyzes an input signal received in response to a manipulation of an actuable button of the keypad sensor. In one example, the keypad sensor is operable to communicate an activation alert to the computer module in response to a predefined prompt. In one example, the activation alert is communicated to the computer module via a BUS message. In another example, the predefined prompt comprises a confidence level percentage, wherein the confidence level percentage is at least 80%.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 illustrates an example sensor system according to the present invention.

FIG. 2 illustrates a timing diagram for an evaluation period of a sensor system according to the present invention.

FIG. 3 is a block diagram illustrating an example method of communicating an activation alert to an electronic system with the sensor system according to present invention.

FIG. 4 illustrates an example sensor system for communicating with a vehicle passive entry and starting (PASE) system according to the present invention.

FIG. 5 illustrates an example keypad sensor for the sensor system as illustrated in FIG. 4.

### DETAILED DESCRIPTION OF THE PREFERRED EMBODIMENT

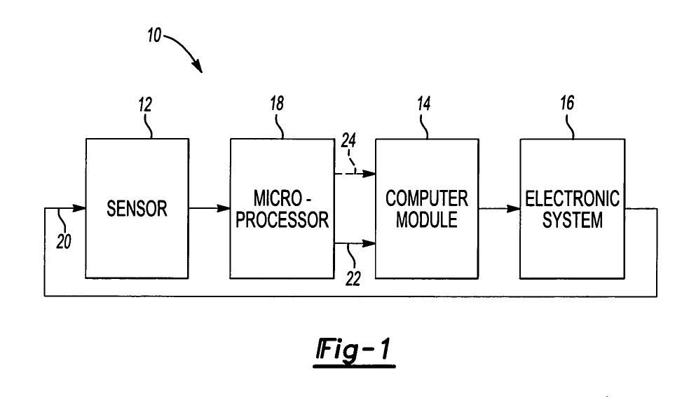

Referring to FIG. 1, a sensor system 10 includes a sensor 12 and a computer module 14. The sensor system 10 communicates with an electronic system 16. The electronic system 16 may include any known electronic system including but not limited to automatic faucet systems, medical devices, security systems, electronic vehicle systems and central heating and cooling systems. A person of ordinary skill in the art with the benefit of the teachings disclosed herein will be able to provide a sensor system for communicating with known electronic systems.

The sensor 12 communicates with a microprocessor 18 for analyzing an input signal 20. In one example, the input signal 20 comprises an electrical signal generated by the actuation of a switch from an “off” position to an “on” position. For example, the input signal 20 may be generated by the actuation of a power switch of a medical device. In one example, the input signal 20 comprises radio frequency (RF) signals. In another example, the input signal 20 includes electrical capacitive signals. It should be understood that the input signal may comprise any communication medium known in the art.

As is known, the microprocessor 18 is programmable to execute a set of instructions. The microprocessor 18 of the sensor 12 evaluates the input signal 20 to determine whether the input signal 20 represents a valid input signal. That is, where the sensor system 10 is connected to a switch, the microprocessor 18 evaluates the input signal 20 received by the sensor 12 to determine whether the switch has been actuated from an “off” position to an “on” position. Due to electrical noise associated with the input signal 20, the input signal 20 is unstable when received by the sensor 12.

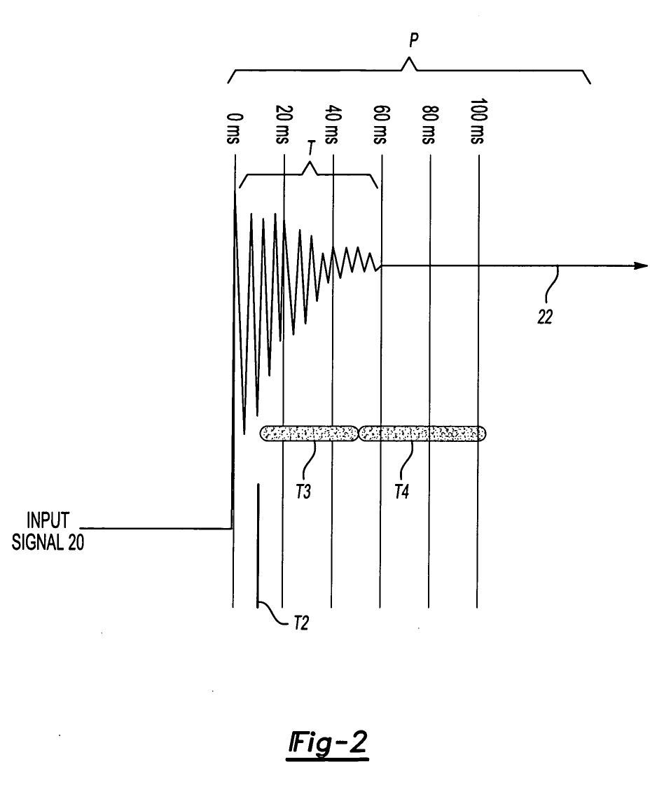

Therefore, the microprocessor 18 evaluates the input signal 20 over an evaluation period P (See FIG. 2) to determine the validity of the input signal 20. In one example, the evaluation period P is approximately 60 milliseconds. A person of ordinary skill in the art would understand that the actual evaluation period P will vary depending upon the type of electronic system 16 that the sensor system 10 is associated with. The microprocessor 18 undergoes an debouncing time T (FIG. 2) associated with the evaluation period P which represents a period of time for which the sensor system 10 waits for the input signal 20 to stabilize and ensure that a true input signal 20 has been received by the sensor 12.

The sensor 12 is also operable to communicate an activation alert 24 to the computer module 14 during the debouncing time T at time T2 (See FIG. 2). In one example, the activation alert 24 is communicated to the computer module 14 via a BUS message. A BUS message is a packet of information (i.e., messages) communicated via a communication bus to share information between the various computer modules utilized by the electronic system 16.

In another example, discrete wiring is connected between the microprocessor 18 and the computer module 14 to communicate the activation alert 24. Discrete wiring is used to communicate information to the computer module via a dedicated electrical signal through a wire which is dedicated to that specific task. It should be understood that the activation alert 24 may be communicated from the microprocessor 18 to the computer module 14 in any known manner.

The activation alert 24 is communicated to the computer module 14 in response to a predefined prompt. In one example, the predefined prompt comprises a confidence level percentage. For example, the microprocessor 18 of the sensor 12 may have an 80% confidence level percentage 20% into the validation cycle. That is, the microprocessor 18 may be 80% confident that the input signal 20 is a valid input signal after approximately 12 milliseconds of the 60 millisecond debouncing time T. A person of ordinary skill in the art with the benefits of the teachings disclosed herein would be able to program the microprocessor 18 to communicate the activation alert 24 in response to any known predefined prompt including but not limited to a lapse of time, a confidence level percentage or any other definable criterion. It should be understood that the amount of time or the level of confidence required to trigger the predefined prompt will vary depending upon the type of electronic system 16 that is being monitored by the sensor system 10.

Once the activation alert 24 is communicated to the computer module 14 signifying that there may be a signal change (i.e., actuation of a switch from an off position to an on position), the computer module 14 begins a startup and initialization sequence for preparing for the receipt of a valid output signal 22. Power is provided to all circuits of the computer module 14 during the startup and initialization sequence.

The computer module 14 receives the activation alert 24 during the debouncing time T rather than after the input signal 20 is debounced. The startup and initialization sequence of the computer module 14 is performed partially in parallel with the evaluation period P of the input signal 20, thereby initializing a reaction time T3 (See FIG. 2) of the computer module 14 earlier in time than if no activation alert 24 were communicated (as illustrated by reaction time T4 in FIG. 2). As illustrated in FIG. 2, the reaction time of a computer module 14 that receives an activation alert begins after approximately 12 ms rather than after approximately 45 seconds where no activation alert is received. Therefore, once the computer module 14 receives the validated output signal 22, the computer module 14 is prepared to communicate with the electronic system 16 to perform the functionality associated with that electronic system 16. For example, where the electronic system 16 is a passive entry and starting (PASE) system for a vehicle, the computer module 14 may command that the vehicle doors be unlocked.

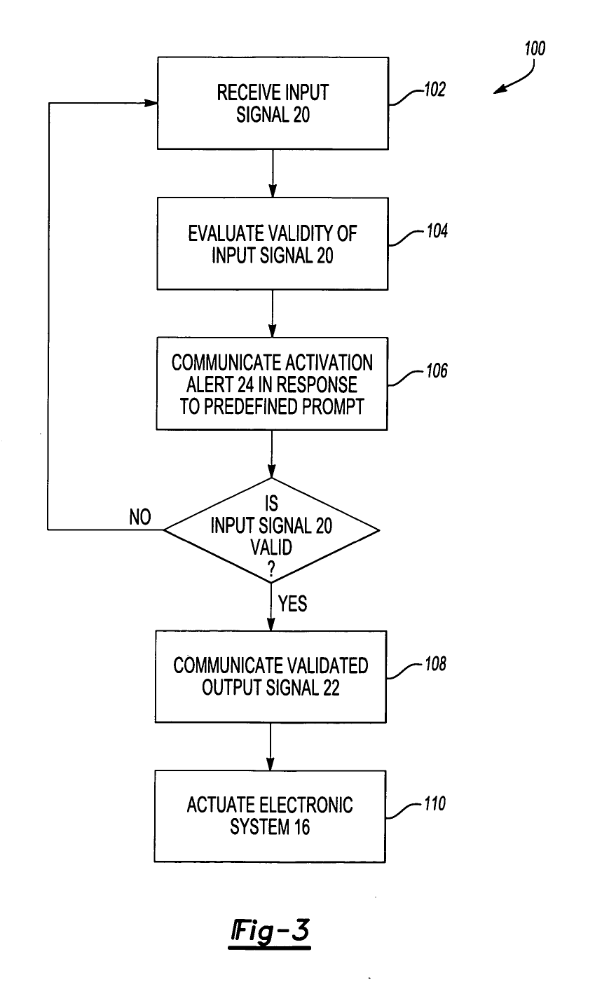

Referring to FIG. 3, and with continuing reference to FIGS. 1 and 2, a method 100 for communicating an activation alert to an electronic system with a sensor system is illustrated. At step block 102, an input signal 20 is received by the sensor 12. In one example, the sensor 12 receives the input signal 20 in response to the actuation of a switch of the electronic system 16 from an “off” position to an “on” position. In another example, the input signal 20 is received by the sensor 12 in response to the manipulation of a button, or in any other known manner. Next, at step block 104, the microprocessor 18 of the sensor 12 evaluates the validity of the input signal 20 received at step block 102. In one example, the input signal 20 is evaluated by analyzing the input signal 20 in 5 millisecond intervals during the debouncing time T. The input signal 20 is filtered to determine whether the input signal 20 represents a valid input signal.

An activation alert signal 24 is communicated to a computer module 14 in response to a predefined prompt at step block 106. The activation alert is communicated at least partially simultaneously with the evaluation of the input signal (step block 104). At this step, the computer module 14 is awakened from a sleep mode and prepared to respond to the computer module 14 in the event a validated output signal 22 is received by the computer module 14. That is, the computer module 14 is awakened from a sleep mode in which part or all of its circuitry is in a low power mode to preserve power, and begins a startup and initialization sequence. During the startup and initialization sequence, the computer module 14 powers up all its circuitry so it may respond to the electronic system 16 in response to the receipt of a validated output signal 22 in an efficient manner.

In one example, the predefined prompt for triggering the activation alert signal 24 comprises a confidence level percentage. The confidence level percentage represents the confidence of the microprocessor 18 that the input signal 20 represents a valid input signal. In one example, the confidence level percentage is at least 80%, although the actual confidence level percentage will vary depending upon the type of electronic system 16 the sensor system 10 is communicating with. In another example, the predefined prompt is a lapse of time.

At step block 108, subsequent to the lapse of the debouncing time T and the determination that the input signal 20 represents a valid input signal, a validated output signal 22 is communicated to the computer module 14. However, if the microprocessor 18 determines that the input signal 20 is not a valid input signal, the method returns to step block 102 where the sensor 12 awaits a new input signal 20 for evaluation.

Finally, at step block 110 the computer module 14 communicates a signal in a known manner, such as through radio frequency (RF) signals, to the electronic system 16 associated with the computer module 14 to accomplish the functionality associated with that electronic system 16. For example, where the electronic system 16 comprises a passive entry and starting PASE) system, the computer module 14 communicates with the PASE system to unlock a vehicle door.

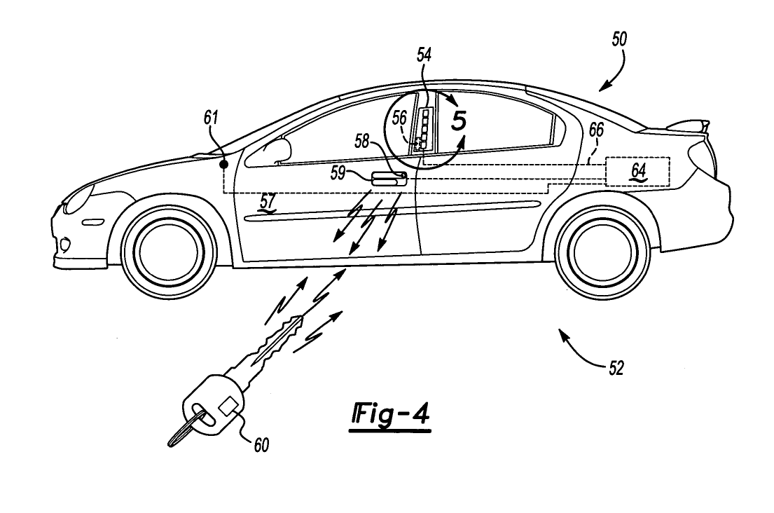

Referring to FIG. 4, a sensor system 50 for a passive entry and starting (PASE) system 52 is illustrated. The sensor system 50 includes a keypad sensor 54 and a computer module 64.

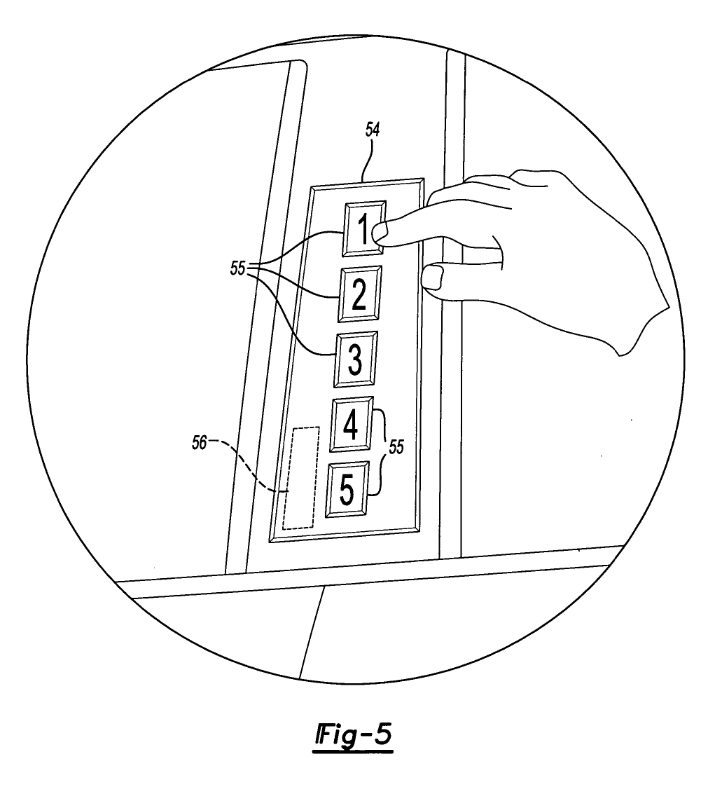

The keypad sensor 54 includes a microprocessor 56. As is known, the microprocessor 56 is programmable to execute a set of instructions. The keypad sensor 54 also includes a plurality of actuable buttons 55 (See FIG. 5) used for entering codes to enable locking and unlocking of a vehicle door 57. The keypad sensor 52 is also utilized to trigger the PASE system 52, as is further discussed below.

In response to receipt of an input signal, such as the actuation of at least one of the plurality of actuable buttons 55 (FIG. 5), the microprocessor 56 analyzes and filters the input signal during the debouncing time of the input signal to determine whether the input signal represents a valid input signal. In one example, the keypad sensor 54 utilizes capacitive sensors to recognize the actuation of one of the plurality of buttons 55. In another example, the output signal is filtered and analyzed during the debouncing time in 5 millisecond intervals to determine the validity of the signal.

Meanwhile, an activation alert 66 is communicated from the keypad sensor 54 to the computer module 64 in response to a predefined prompt. In one example, the activation alert is communicated to the computer module via a BUS message. In another example, the activation alert 66 is communicated to the computer module 64 via discrete wiring which is connected between the computer module 64 and the keypad sensor 54. However, the activation alert 66 may be communicated from the keypad sensor 54 to the computer module 64 in any known manner.

In one example, the activation alert 66 is communicated to the computer module 64 in response to a predefined prompt that includes a specific lapse of time, a confidence level percentage, or any other definable criteria. An example confidence level percentage of 80% will trigger the communication of an activation alert 66 to the computer module 64. The computer module 64 then begins its start up and initialization sequence. Therefore, the evaluation of the input signal by the microprocessor 56 of the keypad sensor 54 and the startup and initialization period of the computer module 64 are provided in parallel with each other, thereby providing improved reaction time of the PASE system 52.

The activation alert 66 awakens the computer module 64 from a sleep mode in which all or part of its circuitry is in a low power or off mode and prepares the computer module 64 to respond by actuating the PASE system 52. An antenna 58 is mounted within a door handle 59 of vehicle door 57 and is electrically connected to the computer module 64 in a known manner. In one example, the antenna 58 is a low frequency antenna having a range of approximately three to six feet.

In response to the receipt of a validated output signal 22, the computer module 64 communicates with the antenna 58. The low frequency antenna 58 is commanded to communicate an output signal in the form of radio frequency (RF) signals. Although the present disclosure is described in terms of radio frequency signals, it should be understood that any known communication medium may be utilized according to the present invention. In the event a transmitter 60 is within the range of the antenna 58, the transmitter 60 receives the output signal from the antenna 58 and communicates an input signal to a remote antenna 61 in the form of radio frequency signals. In one example, the remote antenna 61 is a high frequency antenna mounted within the dashboard of the vehicle. In another example, the antenna is mounted internally to the computer module 64. One example transmitter 60 is a smart key.

The output signal received by the antenna 58 from the computer module 64 is communicated to the microprocessor 56 of the keypad sensor 54. In addition, the remote antenna 61 communicates with the computer module 64 in response to the receipt of an input signal from the transmitter 60. In the event the transmitter 60 is within the desired range of the antenna 58 such that an authorized user is identified, the computer module 64 actuates the PASE system 52 by unlocking the vehicle door 57, for example.

The foregoing description shall be interpreted as illustrative and not in any limiting sense. A worker of ordinary skill in the art would recognize that certain modifications would come within the scope of this invention. For that reason, the following claims should be studies to determine the true scope and content of this invention.

What is claimed is:

1. A sensor system, comprising:
a sensor that receives an input signal; and
a microprocessor in communication with said sensor and operable to analyze said input signal, wherein said microprocessor communicates an activation alert at least partially simultaneously with the analysis of said input signal in response to a predefined prompt.

2. The system as recited in claim 1, wherein said activation alert is communicated to a computer module and said computer module communicates with an electronic system in response to a valid output signal received from said microprocessor.

3. The system as recited in claim 1, wherein said activation alert is communicated via a BUS message.

4. The system as recited in claim 1, wherein said activation alert is communicated via discrete wiring, wherein said discrete wiring is connected between said microprocessor and a computer module.

5. The system as recited in claim 1, wherein said predefined prompt comprises a confidence level percentage.

6. The system as recited in claim 5, wherein said confidence level percentage is at least 80%.

7. A method of communicating an activation alert to an electronic system with a sensor system, comprising the steps of:
(a) receiving an input signal;
(b) evaluating the validity of the input signal received in said step (a);
(c) communicating an activation alert signal to a computer module at least partially simultaneously with said step (b) in response to a predefined prompt; and
(d) communicating a validated output signal to the computer module for controlling the electronic system.

8. The method as recited in claim 7, wherein said step (b) comprises:
analyzing the input signal in five millisecond intervals; and
filtering the input signal to determine the validity of the input signal.

9. The method as recited in claim 7, wherein said step (c) comprises:
awakening the computer module from a sleep mode; and
preparing the computer module to respond to the validated output signal.

10. The method as recited in claim 7, wherein the predefined prompt is a confidence level percentage and said step (c) comprises:
communicating the activation alert in response to the confidence level percentage of at least 80%.

11. The method as recited in claim 7, wherein said step (d) comprises:
(e) actuating the electronic system in response to receiving the validated output signal.

12. The method as recited in claim 7, wherein the electronic system comprises a Passive Entry and Starting (PASE) System and said step (d) comprises:
unlocking a vehicle door in response to receiving the validated output signal.

13. A Passive Entry and Starting (PASE) System for a vehicle, comprising:
a keypad sensor having a microprocessor and at least one actuable button, wherein said microprocessor is operable to analyze an input signal received in response to a manipulation of said at least one actuable button; and
a computer module in communication with said microprocessor of said keypad sensor, wherein said microprocessor is operable to communicate an activation alert to said computer module at least partially simultaneously with the analysis of said input signal in response to a predefined prompt.

14. The system as recited in claim 13, further comprising discrete wiring connected between said keypad sensor and said computer module, wherein said activation alert is communicated to said computer module from said keypad sensor via said discrete wiring.

15. The system as recited in claim 13, wherein said activation alert is communicated to said computer module via a BUS message.

16. The system as recited in claim 13, wherein said predefined prompt comprises a confidence level percentage that is a measure that the input signal is valid, wherein said confidence level percentage is at least 80%.

17. The system as recited in claim 13, wherein said predefined prompt comprises a lapse of time.

18. The system as recited in claim 13, wherein said computer module is operable to actuate said PASE system in response to a valid output signal received from said keypad sensor.

19. The system as recited in claim 13, further comprising at least one antenna in communication with said computer module, said antenna operable to communicate with a transmitter in response to a valid output signal received from said keypad sensor.
